(19) United States
(12) Patent Application Publication
(10) Pub. No.: US 2010/0299021 A1
(43) Pub. Date: Nov. 25, 2010

(54) System and Method for Recording Data Associated with Vehicle Activity and Operation

(76) Inventor: Reza Jalili, Sandy, UT (US)

Correspondence Address: REZA JALILI, 8463 JACKSON HOLE DR., SANDY, UT, 84093, US

(21) Appl. No.: 12/470,330

(22) Filed: May 21, 2009

(51) Int. Cl. G06F 7/00

(52) U.S. Cl. 701/35

(57) ABSTRACT

A system and method for recording data associated with events relevant to the operation of a vehicle. The system can include one or more mechanisms to capture data relevant to operation of a vehicle, such as audio or video data, as well as information pertaining to the activity of the vehicle itself, such as speed, distance, time, and location. Additionally, the system can include a data analysis module that can interact with a network to assist with the enforcement of vehicle operation regulations.

### TECHNICAL FIELD

The present invention is directed towards documenting vehicular activity. In particular, the present invention pertains to a system and method for recording data associated with events relevant to vehicle operation.

### BACKGROUND

Testimony regarding a vehicular accident typically is a case of one participant's statement versus that of another participant. Both may view the other person as the one at fault or a participant may provide a dishonest account of the incident. Even if a third party witness provides testimony regarding the accident, such testimony may be biased by the witness's own prejudices or because he did not see all that transpired. As such, those that must handle the aftermath of an accident, such as law enforcement and insurance agencies, lack an objective record of the event.

A visual and/or audio record of the event as it transpired could serve as objective evidence and validate one's testimony. However, there is no current mechanism that allows a driver to record video, photographs, or audio of an accident in progress. Many personal devices, such as mobile phones, are equipped with digital cameras (for video and/or still images) and audio recorders and may enable one to record evidence, such as vehicle damage and scene details, after an accident has occurred. However, such devices are of no assistance during the most crucial period: when the accident is transpiring. For example, after an automobile accident, a driver may use his mobile phone to take photographs or video of the damage to his vehicle, the condition of the environs, and possibly actions taken by the other individual involved. However, he would have no record of what happened during the accident. Using a personal device while an accident is occurring would be irresponsible as it might result in a more severe accident as one turns his attention from operating his vehicle towards trying to record the event. Additionally, as the driver would be controlling his vehicle at the same time, the data acquired is not likely to be of valuable quality (e.g., shaky camera work).

In addition to there not being a sufficient way to document incidents that transpire in vicinity of a vehicle, there is not a satisfactory way to record the proper or improper operation of the vehicle. For example, there is not a sufficient process for accounting for traffic violations an vehicle operator may conduct. Unless an operator conducts a violation within the view of an enforcement agent, the operator can conduct the violating behavior without suffering any repercussions. Furthermore, as enforcement agents, such as police, often have limited resources, they cannot punish every individual that violates regulations.

What is needed is a convenient and safe mechanism to enable the recording of data associated with vehicle operation as the vehicle is operated.

### SUMMARY OF THE INVENTION

The present invention addresses the aforementioned needs by providing a system and method for recording activity relevant to the operation of a vehicle. By recording such data, the present invention provides a safe and convenient mechanism for one to obtain an objective record of incidents, such as vehicular accidents and vehicle operation violations, as they occur.

### BRIEF SUMMARY OF THE DRAWINGS

In order to describe the manner in which the above-recited and other advantages and features of the invention can be obtained, a more particular description of the invention briefly described above will be rendered by reference to specific embodiments thereof that are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a diagram of an embodiment of a vehicular activity data recording system.

FIG. 2 illustrates a flowchart of an embodiment of a process for recording data associated with activity of a vehicle.

FIG. 3 illustrates a diagram of an embodiment of a database of a data analysis module of a vehicular activity recording system.

FIG. 4 illustrates a diagram of an embodiment of architecture overview of a vehicular activity data recording system network.

### DETAILED DESCRIPTION

Various embodiments of the invention are discussed in detail below. While specific implementations are discussed, it should be understood that this is done for illustration purposes only. A person with ordinary skill in the relevant art will recognize that other components and configurations may be used without parting from the spirit and scope of the invention.

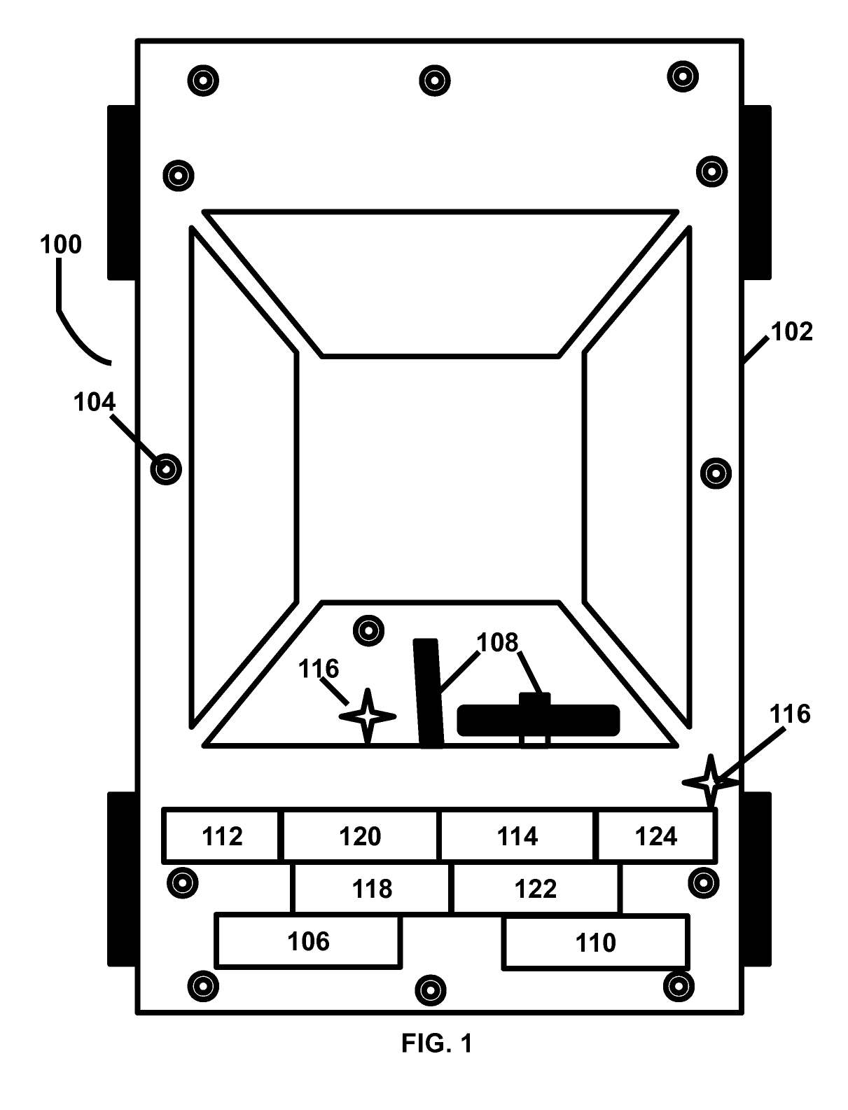

FIG. 1 illustrates a diagram of an embodiment of vehicular activity data recording system (VADRS) 100. Although the VADRS 100 is depicted as including an automobile, this is not to be construed as limiting, as the present invention can be implemented for a variety of vehicles, such as automobiles, motorcycles, trains, and the like. One or more components of the VADRS 100 can be powered by a battery 130, which can be the battery of a vehicle 102 or by an independent battery, such as, for example, a long-lasting lithium battery or a secondary vehicle battery. The VADRS 100 can include one or more recording devices 104. The recording device 104 can be installed during the creation of the vehicle 102 or may be added subsequently (such as by a mechanic or by the owner). A recording device 104 can be any kind of data recording mechanism, such as one that captures video, audio, and/or photographic data. A recording device 104 can be installed so as to be inconspicuous and, therefore, not detract from the appearance of the vehicle 102. For example, as cameras and microphones are now available in minuscule sizes, such as those included in mobile phones, a recording device 104 can be designed to be tiny and flush with the exterior edge of the vehicle 102. As illustrated by FIG. 1, numerous recording devices 104 can be positioned at various points of the vehicle 102. The number and location of recording devices 104 shown is for illustration purposes only and should not be construed as limiting. A recording device 104 can be positioned at any location of the vehicle 102 as would be advantageous to the acquisition of data associated with activity relevant to the vehicle 102, such as the actions of other vehicles, road conditions, and the like. Additionally, one or more recording devices 104 may be positioned to capture data from the interior of the vehicle 102. For example, a recording device 104 may capture video of the instrument panel or the operator. Data captured by a recording device 104 can be transmitted to a temporary memory 106. In one embodiment, the temporary memory 106 is a circular buffer. As is known in the art, a recording device 104, such as a camera, utilizing a circular buffer transfers the data it records sequentially to a memory location. When the memory location is full, data continues to be stored, with the new data overwriting the old. Therefore, the VADRS 100 can continuously record data without filling a data store. In one scenario, the amount of data stored in the temporary memory 106 is based upon time. For example, the temporary memory 106 may record three minutes worth of data before overwriting existing data with new information.

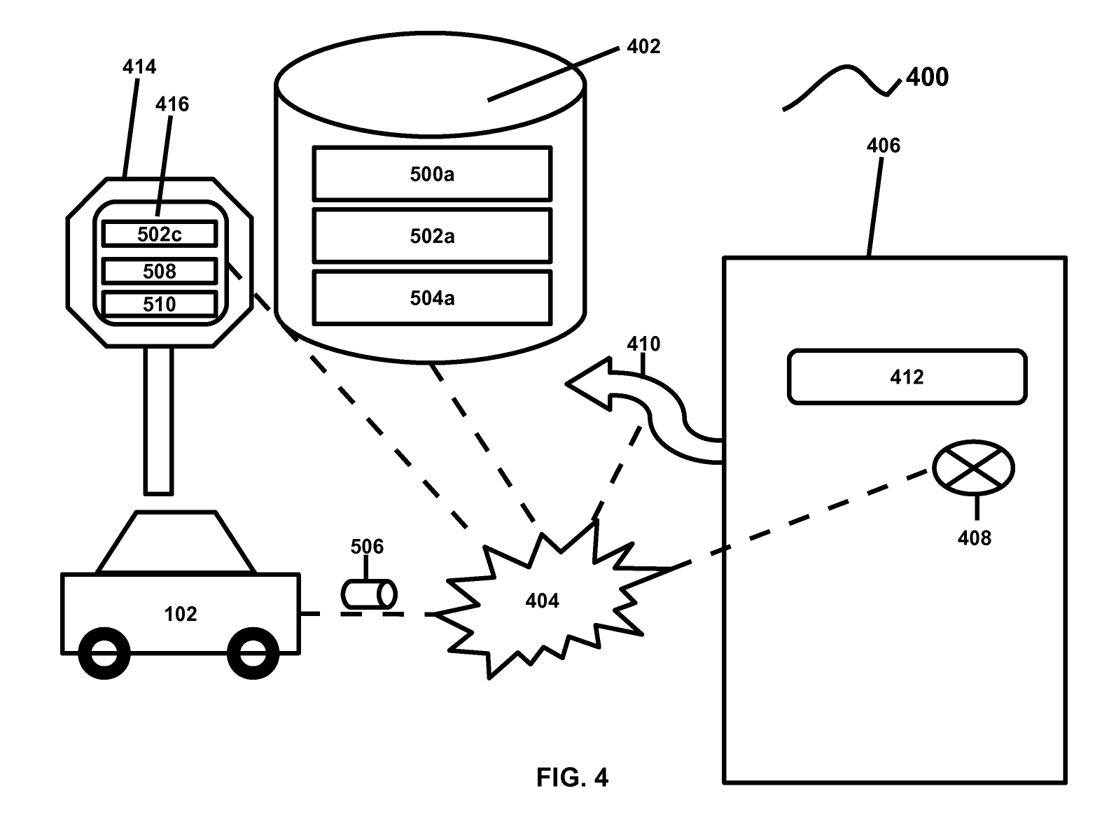

The VADRS 100 can also include a wireless signal interface 126. The wireless signal interface 126 can interact with an external network 404 thereby enabling the VADRS 100 to communicate with components of a VADRS network 400. The VADRS network 400 is described below in relation to FIG. 4.

The VADRS 100 can also include one or more vehicle operation information mechanisms to record and monitor activity information pertaining to the operation of the vehicle 102. For example, the VADRS 100 can include a clock mechanism 112 that maintains a record of the current date and time. The clock mechanism 112 may run independently of other vehicle 102 operations and receive its data from an external source via the wireless signal interface 126. For example, the clock mechanism 112 may receive time and date data via a mobile network, such as those used for mobile phones, rather than being connected to a traditional vehicle clock that is set by the vehicle's operator. Having the time and date data provided via an exterior source can ensure that the clock mechanism 112 maintains an accurate and indisputable time record. The VADRS 100 can also include an odometer mechanism 114 that maintains an accurate record of the distance (e.g., miles or kilometers) the vehicle 102 has traveled. Additionally, a speed mechanism 120 can record and monitor the speed of the vehicle 102. The VADRS 100 can also include a location mechanism 124, such as a global positioning system (GPS) device, that maintains a record of the location of the vehicle 102. Alternatively, rather than having its own location mechanism 124, if the vehicle 102 is equipped with its own location device (e.g., GPS navigation device), the VADRS 100 can interface with this device to obtain location data.

Additionally, the VADRS 100 can include a presentation mechanism 128, such as a display screen or speaker, to present data captured by a recording device 104, a vehicle operation information mechanism 112, 114, 120, 124, and/or the wireless signal interface 126. For example, a presentation mechanism 128 may be a display screen and present video data, such as views of the blind spots of the vehicle 102. In one embodiment, the VADRS 100 may not include its own presentation mechanism 128, but rather can interface with an existing system of the vehicle 102 for this functionality. For example, if the vehicle 102 has a GPS device with visual and audio outputs, the VADRS 100 can interface with this device for presentation purposes.

The VADRS 100 can include a trigger 108 in order to initiate the storing of data recorded in the temporary memory 106 to a long-term memory 110. In one embodiment, the trigger 108 may be a lever, button, switch, or the like located within reach of the operator. For example, if the vehicle 102 is an automobile, the trigger 108 can be located on the steering wheel, on a steering column lever, on the dashboard, or on the floor console. Although the vehicle 102 is shown as having two triggers 108, this is for illustrative purposes only, as a vehicle 102 may be equipped with only one. In one embodiment, the trigger 108 can be located within reach of a passenger of the vehicle 102, thereby allowing a passenger to employ the trigger 108 in addition to, or instead of, the operator. In another embodiment, the trigger 108 can be activated without an extraneous action by the operator or a passenger and may not be accessible by the operator or a passenger. For example, the trigger 108 may be activated based upon a sudden impact or physical shock to the vehicle 102 or when protective systems of the vehicle 102, such as an airbag system, anti-lock brakes, an emergency brake, or horn, are activated. In one scenario, if pressure is applied to the brake pedal with a certain amount of force, or if pressure is applied suddenly rather than gradually, the trigger 108 activates. Alternatively, the trigger 108 can be activated by events detected by one or more components of the VADRS 100. Data acquired from a recording device 104, such as the presence of an object (e.g., another vehicle) within close proximity of the vehicle 102, may activate the trigger 108. For example, if a recording device 104 is enabled to capture video data, a sudden change to the image in its field of view or if an object in the field of view suddenly becomes larger or covers the field of view, may activate the trigger 108. Additionally, if the wireless signal interface 126 receives a transmission from a specially equipped traffic element 414, such as a traffic sign or traffic signal, the trigger may activate 108. For example, a traffic signal may transmit a wireless transmission when it turns red. The trigger 108 may activate if the VADRS 100 receives a red light signal, but the vehicle 102 does not slow down. Further details regarding specially equipped traffic elements 414 and their interaction with the VADRS 100 are subsequently detailed.

When the trigger 108 is activated, a particular amount of recorded data is transferred from the temporary memory 106 to the long-term memory 110. This data can include a particular range of data recorded prior to the activation of the trigger 108 and a particular range of data recorded subsequent to the activation of the trigger 108, such as the thirty seconds of data recorded before and after. The particular range of data stored can vary per implementation, but generally the data saved will have been recorded sequentially within a particular time span sufficient to reflect an incident, such as an accident, associated with operation of the vehicle 102. The time span may be established by the owner or another party, for example, an insurance agency representative, the vehicle manufacturer, or the provider of the VADRS 100.

Vehicle operation information recorded by one or more vehicle operation information mechanisms 112, 114, 120, 124 can be associated with the recorded data stored to the long-term memory 110. For example, the odometer information at the time of the activation of the trigger 108 can be associated with the recorded data. As another example, the speed mechanism 120 can provide the speed of the vehicle 102 at the time of trigger 108 activation. Furthermore, data received by the wireless signal interface 126, such as from a beacon 416 of a traffic element 414, can be associated with the data stored to the long-term memory 110.

In addition to the aforementioned memory mechanisms, the VADRS 100 can include one or more storage medium interfaces 116 to enable the transmission of data from the long-term memory 110 to another storage medium. A storage medium interface 116 can be a wireless interface or a physical input. For example, a storage medium interface 116 can be a Universal Serial Bus (USB) port, a CD-ROM recorder, a DVD recorder, a cassette (audio and/or video) recorder, or the like. The VADRS 100 can include more than one storage medium interface 116 and more than one type of storage medium interface 116. As illustrated by FIG. 1, a storage medium interface 116 can be located on the interior or exterior of the vehicle 102. For example, if the vehicle 102 is an automobile, the storage medium interface 116 can be a USB port located on the dashboard, the console, or one located underneath the hood or fender. A storage medium interface 116 located on the exterior of the vehicle 102 can be covered by lid, cap, hatch, or the like to protect it from the elements.

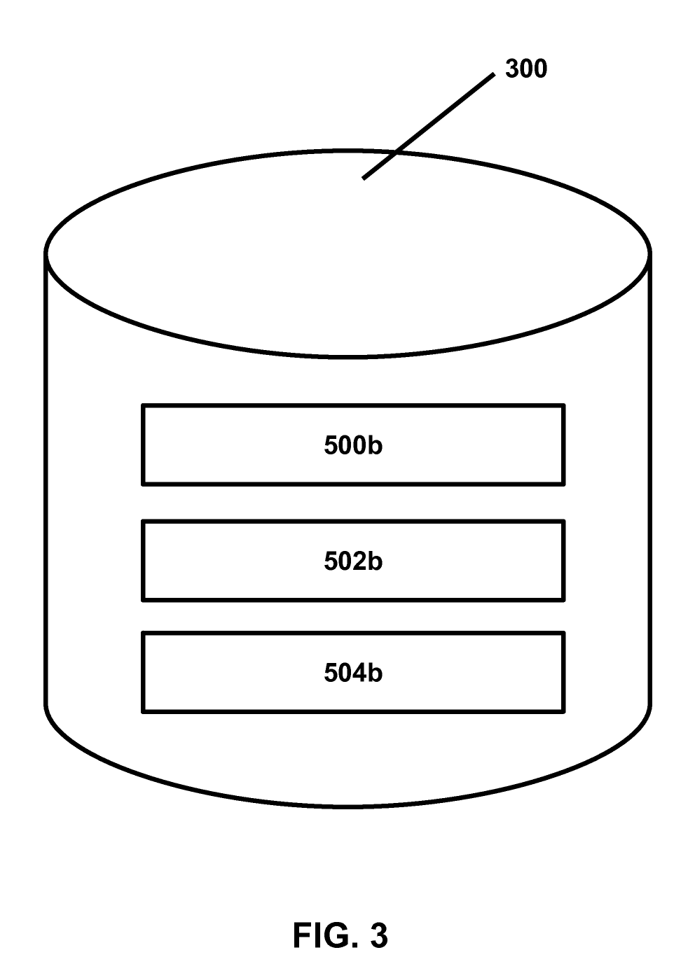

The VADRS 100 can include a data analysis module 122 that may analyze the data stored in the long-term memory 110 in order to ascertain particular information. In one embodiment, the data analysis module 122 may search for information associated with captured images of vehicles. For example, the data analysis module 122 may search a frame of video for a license plate number, a vehicle model name, a vehicle make logo, a color, or the like. As illustrated by FIG. 4, in one embodiment, the VADRS 100, and thereby the data analysis module 122, may have access to a database of vehicle operator information 500a and regulation data 502a maintained at an external server 402, such as a police station server, a traffic regulatory server, or an insurance company data server. Furthermore, the VADRS 100 may have access to regulation data 502c broadcast by the beacon 416 of a traffic element 414. The VADRS 100 can communicate with the server 402 or the beacon 416 via network 404 (e.g., a mobile network). As aforementioned, the VADRS 100 can interact with an external network 404 via the wireless signal interface 126. Alternatively (or additionally), the data analysis module 122 may maintain its own database 300, as illustrated by FIG. 3, which can contain vehicle operator information 500b, regulation data 502b, and the like. As the database 300 may contain sensitive information, it may be secured such that only authorized individuals (e.g., law enforcement, insurance agency employees, etc.) may access it. The data analysis module 122 may determine if any vehicle operator information 500a, 500b is associated with data stored in the long-term memory 110. For example, if the data analysis module 122 identified a license plate number, it may find the corresponding driver's license information. Furthermore, the data analysis module 122 can determine if a violation has occurred per regulation data 502a, 502b, 502c. If so, it can log the particulars of the violation for future action in the database 300 as a violation record 504b, or the violation data can be transmitted to the server 402 for logging (i.e., violation record 504a). A violation record 504a, 504b can include various information about the violation, such as the date, time, location, a description of the incident, the associated fine, or the like. Alternatively, or additionally, the complete stored data or a relevant portion may be transmitted. During transmission, violation data can be transmitted as an encrypted data message 506. The data analysis module 122 can also access and utilize recording devices 104 such as, for example, the video buffers of a camera, to detect particular traffic elements 414 in the captured environs and, if appropriate, detect changes to such traffic elements 414. For example, the data analysis module 122 may detect a stop sign or a yield sign in the field of view of a camera, or may detect a change in a traffic signal, such as the traffic signal changing from yellow to red. As aforementioned, the wireless signal interface 126 can also detect signals transmitted from traffic elements 414 equipped with beacons 416. For example, a traffic signal or sign can be equipped with a beacon 416, such as an RFID device, and the beacon can broadcast information to the VADRS 100. Beacon information can include regulation data 502c, a traffic element identifier 508 identifying the associated traffic element 414 (e..g, stop sign, traffic signal, etc.), and location data 510 associated with the traffic element (e.g., a mile marker number, street information, or coordinates), and the like. For example, the beacon information can indicate that the traffic element 414 is a stop sign at the intersection of Route 980 and Route 19 and that the penalty for running the stop sign is $50.00 fine. Furthermore, if the traffic element 414 has an active functionality, such as a traffic light, the beacon 416 may change its broadcast to reflect current activity. For example, a traffic light beacon may change its broadcast per the current activated light. A detected traffic element 414 can be indicated on the instrument panel of the vehicle 102 or via the presentation mechanism 128. For example, an indicator light or an audio message could be provided in the interior of the vehicle 102, such as via a speaker system. As aforementioned, the VADRS 100 can include, or can work in conjunction with, a GPS navigation device, thereby enabling such a device to warn the operator of traffic elements 414 in addition to providing him with operating instructions. For example, the VADRS 100 may provide an audio warning such as “You are approaching a red light at the intersection of Grant Avenue and Main Street.”

In one embodiment, beacon information received by the VADRS 100 can be compiled by the VADRS network provider. For example, although the VADRS 100 can interact with traffic elements 414 equipped with beacons 416, the VADRS network provider may not have a complete record of every beacon 416 and/or its data. For example, the traffic elements 414 may be installed by another party, such as a the Department of Motor Vehicles. Alternatively, although the VADRS 100 might have a record of the initial set of beacons 416, it may not have ready access to ones newly installed. As such, as the vehicle 102 travels, the VADRS 100 can log the beacon information it receives from beacons 416 it encounters. The VADRS 100 can relay this information to a server 402 so that the VADRS network provider can update its records and thereby ensure it has accurate information. Additionally, or alternatively, this information could be provided to a third party, such as a GPS navigation system provider.

The VADRS 100 can also include a controller 118. A controller 118 can be a computerized mechanism that coordinates the interaction of the various system components. For example, the controller 118 can manage the transfer of data from a recording device 104 to the temporary memory 106, the transfer of data from the temporary memory 106 to the long-term memory 110, and the association of vehicle operation information with the recorded data stored to the long-term memory 110. Furthermore, the controller 118 can manage the transfer of data stored in the long-term memory 110 to an external storage medium via a storage medium interface 116. The controller 118 may also manage the transmission and receipt of data from the VADRS 100 and an external component, such as a server 402, a traffic element 414, or an enforcement kiosk 406.

Although several components of the VADRS 100 have been described, this is not to be construed as limiting or exhaustive. Although not illustrated in FIG. 1, the internal components of the VADRS 100 can be connected by one or more types of known data networks, such as a wired and/or wireless network.

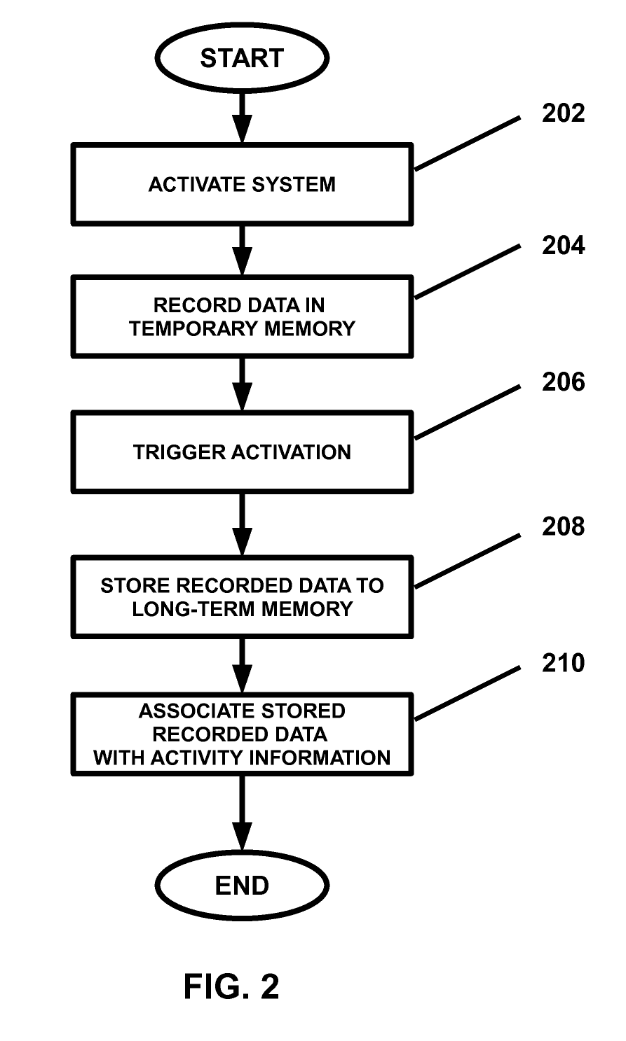

FIG. 2 illustrates a flowchart of an embodiment of a process employing the VADRS 100. The VADRS 100 is activated (step 202). In one embodiment, the VADRS 100 is activated when the vehicle 102 itself is activated. In another embodiment, the operator of the vehicle 102 can manually activate the VADRS 100. Alternatively, the VADRS 100 is always active. As aforementioned, the VADRS 100 can be powered by its own battery, thereby alleviating any possibility it may drain the battery powering the vehicle 102. Once activated, the recording devices 104 and vehicle operation information mechanisms 112, 114, 120, 124 can begin recording and monitoring data associated with the operation of the vehicle (step 204). Unless the trigger 108 is employed, the VADRS 100 will simply record and monitor data until it is deactivated (if ever). However, if the trigger 108 is activated (step 206), the recorded data held in the temporary memory 106 can be stored to the long-term memory 110 (step 208). As mentioned, the trigger 108 can be activated by the operator or a passenger of the vehicle 102 or the trigger 108 can be activated automatically per various stimuli to the VADRS 100.

The VADRS 100 can record data regarding an incident involving the vehicle 102; however the nature of the incident can vary. For example, the trigger 108 may be activated during a collision. However, the VADRS 100 need not be limited to recording accident information. An operator can utilize the VADRS 100 to record any data relevant to the operation of his vehicle 102. For example, one can utilize the VADRS 100 to record another person's aggressive or reckless driving, capturing the details of the other vehicle, including its license plate number. Furthermore, the VADRS 100 can record data regarding the operation of the vehicle 102 itself.

In addition to storing the recorded data from the temporary memory 106 to the long-term memory 110, vehicle operation information obtained from a vehicle operation information mechanism 112, 114, 120, 124 can be associated with the data stored in the long-term memory 110 (step 210). The stored data can be later retrieved via a storage medium interface 116. For example, an individual can download the stored data to a USB memory stick or transfer it to a server 402.

Data recorded and stored by the VADRS 100 can be employed for various functions. For example, in regards to an automobile accident, a driver can provide such data to validate his account of what happened during an accident when filing an insurance claim. As another example, if the operator employed the VADRS 100 to save data illustrative of another individual's criminal behavior, the operator can provide the data to the proper authorities. Stored data can be retrieved by the operator himself or, alternatively, by an authorized individual, such as an insurance agency representative or a police officer. In one scenario, only an authorized individual can access the stored data. This may be necessary to prevent tampering. For example, an operator that knows he was at fault in an accident may wish to destroy the data before it is seen by someone else. Various security systems known in the art can be used to prevent an unauthorized individual from gaining access.

Although the VADRS 100 has been described mainly in terms of recording the activity external to the vehicle 102, this is not to be construed as limiting, as the VADRS 100 can monitor the operation of the vehicle 102 itself. As previously mentioned, the trigger 108 can activate automatically and, as such, can activate whether the operator wishes it to or not. For example, the data analysis module 122 can receive regulation data 502a, such as a speed limit or parking rules for the current location of the vehicle 102, via the network 404. Regulation data 502a, 502c can be received from a server 400, a beacon 416, or the data analysis module 122 may already have it within its database 300 (i.e., 502b). The location of the vehicle 102 can be determined by the location mechanism 124, such as via triangulation, GPS coordinates, or the like. One or more of vehicle operation information mechanisms 112, 114, 120, 124 can provide the data analysis module 122 with a continuous feed of data regarding the operation of the vehicle 102. Furthermore, the data analysis module 122 can access the data being captured by a recording device 104 or from a beacon 416 via the wireless signal interface 126. If the data analysis module 122 receives data indicative of a violation, it can log this data as a violation record 504b. In one embodiment, the data analysis module 122 activates the trigger 108 when it detects activity indicative of a violation, thereby causing the data recorded by a recording device 104 to be transferred to the long-term memory 110. For example, if speed information provided by the speed mechanism 120 indicates that the vehicle 102 has exceeded the current speed limit, it may log this violation. As another example, captured video data may indicate that the vehicle 102 crossed the center lane in a no passing zone. The data analysis module 122 can also analyze this information to determine if the vehicle 102 has violated any regulations indicated by the regulation data 502a, 502b. In one embodiment, if the data analysis module 122 determines that the current operation of the vehicle 102 is in violation of a regulation (or likely soon will be given current data), the VADRS 100 may indicate this to the driver via the presentation mechanism 128. Regulation data 502a, 502b, 502c can indicate a time period in which an operator may correct his behavior in order to avoid a penalty for the violation. For example, the presentation mechanism 128 may notify the operator that he is traveling 70 MPH in a 55 MPH zone and that unless he reduces his speed in the next ten seconds, the violation will be recorded. As another example, the presentation mechanism 128 may notify the operator that he has parked in a tow-away zone and that he has ten seconds to move his vehicle before the violation is recorded.

A violation record 504b can be transmitted from the data analysis module 122 to a server 402, such as a traffic violations regulatory server operated by a legal authority. As previously mentioned, the server 402 can contain vehicle operator information 500a associated with the vehicle 102, such as the contact information of the owner and/or operator. Alternatively, vehicle operator information 500b can be stored in the database 300 of the data analysis module 122 and can be transmitted in conjunction with a violation record 504b. As aforementioned, violation data can be transmitted in an encrypted format (i.e., data message 506). The legal authority can utilize the violation record 504a and the vehicle operator information 500a to contact the operator, typically to obtain payment for a fine associated with the violation. For example, if the legal authority receives a violation record 504a indicating that the vehicle 102 exceeded a speed limit, the operator may receive a traffic ticket in the mail. Alternatively, the VADRS 100 itself can determine a fine to be charged for a violation. The regulation data 502b maintained in the database 300 of the data analysis module 122 can indicate the appropriate fines for various violations or the data analysis module 122 may access regulation data 502a from the server 402 via the network 404. The data analysis module 122 can compare regulation data 502a, 502b, 502c with information received from the vehicle operation information mechanisms 112, 114, 120, 124 or extracted from stored recorded data and log violations and their appropriate fines in a violation record 504b. As previously mentioned, the violation data can be transferred (i.e., data message 506) to a server 402 maintain by a third party, such as a legal authority, and the operator may be contacted as aforementioned.

Alternatively, violations can be resolved in another fashion. As illustrated by FIG. 4, the VADRS 100 can interact with various components of a VADRS network 400, such as an enforcement kiosk 406. An enforcement kiosk 406 can be an unmanned apparatus that allows an operator to pay any fines associated with violation records 504a, 504b he has accrued. In an alternate embodiment, the enforcement kiosk 406 is a manned apparatus. In one scenario, an enforcement kiosk 406 is a specially designed or specially equipped fuel pump. The enforcement kiosk 406 can receive a violation record data message 506 from the VADRS 100 via a wireless interface 408 or with a physical interface 410. For example, the enforcement kiosk 406 may be a fuel pump equipped with an RFID receiver, such as Exxon's SpeedPass receiver, and the wireless signal interface 126 can transmit an RFID signal to it. Alternatively, the enforcement kiosk 406 may receive a violation record data message 506 via a physical interface 410. For example, the enforcement kiosk 406 may be a fuel pump equipped with a specially designed nozzle that receives data from the VADRS 100 once the nozzle is inserted into the vehicle 102. Once the VADRS 100 has interfaced with the enforcement kiosk 406, the VADRS 100 can relay violation record 502b data to the enforcement kiosk 406, and the operator can be prompted to pay an associated fine via a variety of methods (e.g., credit, debit, cash, etc.). If the enforcement kiosk 406 is a fuel pump, the operator may be prompted to pay for the fine in addition to the charge for fuel. The enforcement kiosk 406 can include a fuel regulator 412 that may prohibit the dispensing of fuel until the operator has paid any fines associated with a violation record 504b. If the particulars of a violation record 504b indicate a particularly serious violation or if the VADRS 100 provides a number of violation records 504b in excess of a particular threshold, the fuel regulator 412 can prevent the dispensing of fuel even if the operator pays the associated fines. Once the operator has paid, the enforcement kiosk 406 can transmit a payment indication to the VADRS 100 and the data analysis module 122 can note that the fine has been paid. For example, the data analysis module 122 may mark a violation record 504b as paid or may delete the violation record 504b from its database 300. Alternatively, an indication that a violation has been paid can be transmitted to the server 402.

Regardless of the particulars of payment, such a system can enable an operator to be fined for all violations he conducts, rather than simply for those that were noticed by law enforcement. As such, the dollar amount of the fines may be lower than those typically employed because the operator is likely to be obligated to pay more fines than he would via the traditional manner.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention. Therefore, the above description should not be considered to be exclusive of these other embodiments. Also, it is to be understood that the phraseology and terminology employed herein are for the purposes of description and should not be regarded as limiting.

What is claimed is:

1. A system for recording data associated with a vehicle, the system comprising:
a. a vehicle;
b. a recording device, wherein the recording device continuously captures data associated with activity of the vehicle;
c. a vehicle operation information mechanism, wherein the vehicle operation information mechanism continuously monitors one or more elements of vehicle operation;
d. a first memory for recording the activity data captured by the recording device, wherein the first memory is a circular buffer;
e. a second memory for storing recorded activity data received from the first memory; and
f. a trigger, wherein activation of the trigger initiates the storing of recorded activity data from the first memory to the second memory in association with one or more elements vehicle operation information.

2. The system of claim 1, further comprising an interface, wherein the interface enables the communication of the stored data from the second memory to an external memory medium.

3. The system of claim 1, wherein the recording device captures one or more of video data, photographic data, and audio data.

4. The system of claim 1, further comprising a presentation mechanism, wherein the presentation mechanism presents one or more of activity data and vehicle operation information to one or more of an operator and a passenger of the vehicle.

5. The system of claim 1, wherein the trigger is a manual trigger.

6. The system of claim 1, wherein the trigger is an automatic trigger.

7. The system of claim 1, wherein the trigger activation corresponds with the activation of a protective system of the vehicle.

8. The system of claim 1, wherein the recorded activity data stored to the second memory comprises data captured a particular amount of time before the activation of the trigger.

9. The system of claim 1, wherein the recorded activity data stored to the second memory comprises data captured a particular amount of time after the activation of the trigger.

10. The system of claim 1, wherein an element of vehicle operation information includes date information, time information, information associated with distance traveled by the vehicle, vehicle speed information, or vehicle location information.

11. The system of claim 1, further comprising a wireless signal interface.

12. The system of claim 11, wherein the wireless signal interface enables the receipt of regulation data from an external mechanism.

13. The system of claim 1, further comprising a data analysis module, wherein the data analysis module analyzes one or more of recorded activity data and vehicle operation information.

14. The system of claim 13, wherein the data analysis module is enabled to determine if a violation has occurred per its analysis of one or more of recorded activity data and vehicle operation information.

15. A method for recording data associated with a vehicle, the method comprising:
a. initiating the capture of data associated with activity of a vehicle;
b. recording the captured data in a circular buffer;
c. receiving an activation signal from a trigger;
d. storing the captured data recorded in the circular buffer to a long-term memory; and
e. associating the data stored to the long-term memory with vehicle operation information associated with the activation of the trigger.

16. The method of claim 15, further comprising communicating data stored in the long-term memory to another storage medium.

17. The method of claim 15, further comprising determining whether data stored in the long-term memory is indicative of a violation.

18. A method for recording a violation of a vehicle operation regulation, the method comprising:
a. receiving, at a vehicular activity recording system, data pertinent to vehicle operation regulation enforcement, wherein the vehicular activity recording system is located within a vehicle;
b. recording, via the vehicular activity recording system, data associated with the operation of the vehicle;
c. evaluating the recorded vehicle operation data per the vehicle operation regulation enforcement data; and
d. if the evaluation indicates activity that violates a vehicle operation regulation, storing one or more elements of the recorded vehicle operation data indicative of the violation.

19. The method of claim 18, wherein vehicle operation regulation enforcement data includes one or more of vehicle operator information, and regulation data.

20. The method of claim 18 further comprising transmitting data indicative of the violation to an external mechanism.
